(19) United States
(12) Patent Application Publication
(10) Pub. No.: US 2018/0189813 A1
(43) Pub. Date: Jul. 5, 2018

(54) HISTORIC VALUE BASED PREDICTIVE OPTIONS COMMERCE

(71) Applicant: Alex NEAL, Encinitas, CA (US)

(72) Inventor: Alex NEAL, Encinitas, CA (US)

(21) Appl. No.: 15/298,259

(22) Filed: Oct. 20, 2016

Related U.S. Application Data
(63) Continuation-in-part of application No. 15/089,154, filed on Apr. 1, 2016.
(60) Provisional application No. 62/203,008, filed on Aug. 10, 2015.

(51) Int. Cl. G06Q 30/02; G06Q 30/06

(52) U.S. Cl. CPC G06Q 30/0206; G06Q 30/0629; G06Q 30/0645; G06Q 30/0202; G06Q 30/0631

(57) ABSTRACT

A novel system and apparatus predicts future consumer item buyback prices based on historical pricing and estimated depreciation. The estimated future buyback price is used to determine the current net cost of purchasing an item compared to the net cost of renting the item. Personal preference factors are evaluated and a commerce option recommendation is made with an associated confidence rating. A user is also provided with a graphical price history of the item. Thus, a Historic Value Based Predictive Options Commerce system assists a consumer in deciding whether to purchase or rent a considered item, by providing the user with a system to allow consumers to transparently evaluate the net cost of ownership versus rental commerce options. A commerce recommendation and/or confidence rating may be associated with the commerce options.

### CLAIM OF PRIORITY UNDER 35 U.S.C. § 119

The present Application for Patent claims priority to Provisional Application No. 62/203,008 entitled “HISTORY BASED OPTIONS COMMERCE” filed Aug. 10, 2015, and hereby expressly incorporated by reference herein.

### CLAIM OF PRIORITY UNDER 35 U.S.C. § 120

The present Application for Patent is a Continuation in Part of patent application Ser. No. 15,089,154, entitled “HISTORIC VALUE BASED PREDICTIVE OPTIONS COMMERCE” filed Apr. 1, 2016, and claiming a priority filing date of August 10, 2015, pending, and hereby expressly incorporated by reference herein.

### FIELD

The present application relates generally to the technical field of improvements to computer functioning and, in one example embodiment, to a system and apparatus for predictive valuing of commercial items based on historic buyback value.

### BACKGROUND

A user searching an information resource (e.g., database) may encounter challenges. One such challenge may be that a search mechanism (e.g., a search engine) that is utilized to search the information resource may return search results that offer a user only one option for acquiring a requested item, without providing any further information regarding the historical value of the considered item. For example, the search mechanism may respond to a query from users acquiring text books for the duration of a school term or longer. Currently, user interfaces neither consider pricing history and trends regarding future product values, nor provide users with a transparent net total cost of ownership calculation for an item purchase cost versus a rental fee. Thus, there is a need for a rental cost versus purchase price comparison tool to recommend whether a consumer should buy or rent a particular item based on a sophisticated algorithm that considers pricing history and future value trends, to give users a more transparent total cost of ownership calculation for item purchases or rentals.

### BRIEF DESCRIPTION OF THE DRAWINGS

The features and nature of the present invention will become more apparent from the detailed description set forth below when taken in conjunction with the drawings in which like reference characters identify correspondingly throughout.

FIG. 1 is a block diagram depicting a system suitable for Historic Value Based Predictive Options Commerce, according to some example embodiments;

FIG. 2 is a block diagram illustrating a network-based publication system for processing a search engine query, and presenting search results (e.g., marketplace listings) pertaining to Historic Value Based Predictive Options Commerce, as described more fully herein;

FIG. 3 shows a functional block diagram of Historic Value Based Predictive Options Commerce system operations, according to some example embodiments;

FIG. 4 shows a detailed state diagram illustrating a Historic Value Determination Procedure, or historical pricing calculation, according to some example embodiments;

FIG. 5 shows a detailed state diagram for a Buyback Value Forecast Procedure, according to some example embodiments;

FIG. 6 shows a detailed flow chart for a Commerce Option Vetting Procedure, according to some example embodiments;

FIG. 7 shows a detailed state diagram illustrating a Commerce Option Comparator Procedure, according to some example embodiments.

FIG. 8 shows a detailed state diagram illustrating a Commerce Option Final Confidence Rating Procedure, according to some example embodiments;

FIG. 9. illustrates a user interface for Historic Value Based Predictive Options Commerce, according to some example embodiments;

FIG. 10. illustrates another user interface for Historic Value Based Predictive Options Commerce, according to some example embodiments; and

FIG. 11 is a block diagram illustrating components of a machine, according to some example embodiments, able to read instructions from a machine-readable medium and perform any one or more of the systems and methodologies for Historic Value Based Predictive Options Commerce discussed herein.

### DETAILED DESCRIPTION

The word “exemplary” is used exclusively herein to mean “serving as an example, instance, or illustration.” Any embodiment described herein as “exemplary” is not necessarily to be construed as preferred or advantageous over other embodiments.

The term “commerce option” is defined herein as any purchase-only alternative method of item acquisition.

Example methods and systems for Historic Value Based Predictive Options Commerce are described. In the following description, for purposes of explanation, numerous specific details are set forth in order to provide a thorough understanding of example embodiments. It will be evident, however, to one skilled in the art that the present invention may be practiced without these specific details.

In some embodiments, for simplification and ease of understanding, Historic Value Based Predictive Options Commerce is detailed in relation to exemplary text book acquisitions, although one skilled in the art would understand that other embodiments may pertain to any commercial product, retail item, or other personal or real property. Other exemplary embodiments may apply to acquisition of vehicles, musical instruments, real estate, boats, airplanes, furniture, electronics, appliances, tools, sporting equipment, clothing, or acquisition of any goods or item having a net cost of ownership.

According to an exemplary text book embodiment, Historic Value Based Predictive Options Commerce's buy versus rent cost-comparison tool recommends whether a book buyer should buy or rent a particular book based on a sophisticated algorithm detailed below that considers pricing history and trends regarding future book values, which provides users with a more transparent total cost of ownership calculation for exemplary book items. Not only does the tool make a consumer recommendation, it also provides a recommendation confidence rating to further assist the consumer in item acquisition decision making.

In the exemplary text book embodiment, Historic Value Based Predictive Options Commerce operations estimate future book buyback values based on historical sale prices and estimated appreciation/depreciation, and uses this estimated future buyback value to determine a current net cost of purchasing a book by comparing a net purchase price to a rental fee for the book. Individual consumer related variables, or personal preference factors, may be taken into account, including the duration of time the user needs to keep the book, the estimated condition of the book after use, and the risk profile of the book buyer. Finally, the system provides the user with a graphical price history of the book and a consumer recommendation with an associated confidence rating.

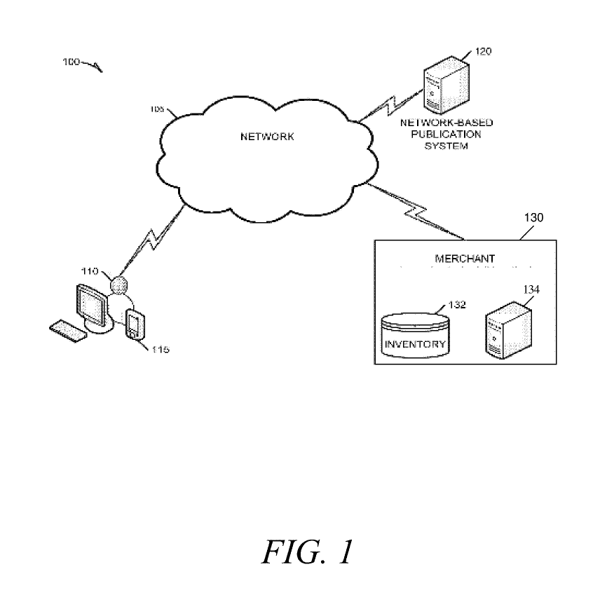

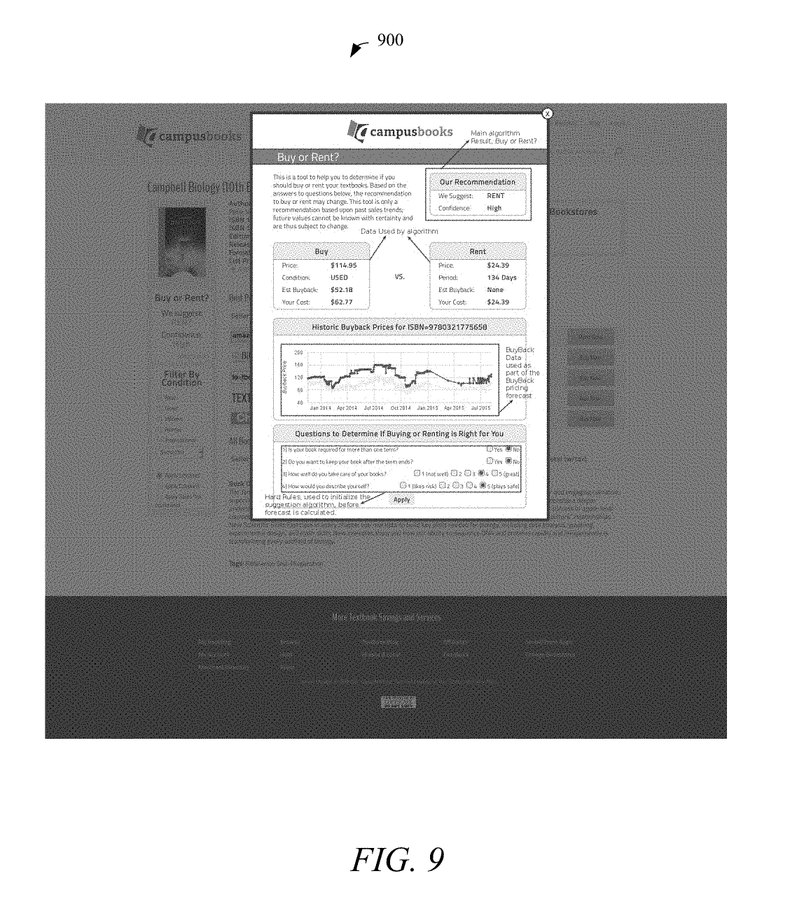

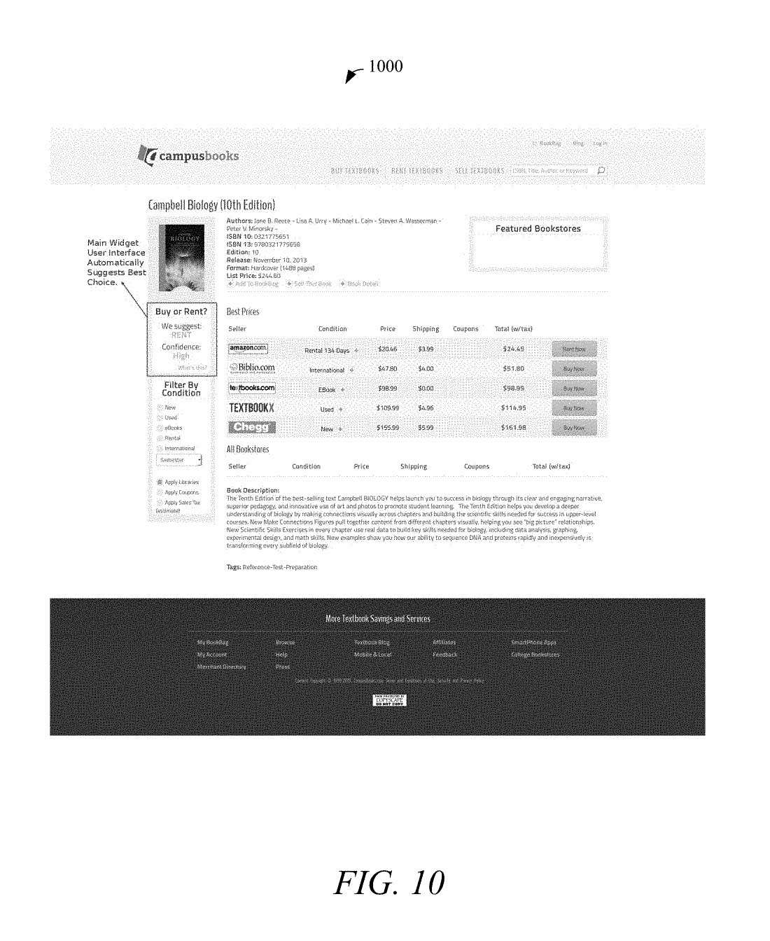

FIG. 1 is a network diagram illustrating a network environment suitable for Historic Value Based Predictive Options Commerce, according to some example embodiments. FIG. 1 shows a block diagram depicting a system 100 for identifying requested items and offering commerce option benefits to users (i.e. consumers). The system 100 can include a user 110, a network-based publication system 120 having a search engine, and one or more affiliated merchants 130. Other embodiments may provide third party program partners with data for offering historic value based predictive commerce option through a proprietary Application Programming Interface (API). In one example, the user 110 can connect to the network-based publication system 120 via a client computing device 115 (e.g., desktop, laptop, smart phone, Personal Digital Assistant (PDA), or similar electronic device capable of data connectivity) and network 105. The network-based publication system 120 will receive and process a requested item query from the user's client computing device 115, and return commerce option results in a search results page or similar user interface detailed in FIGS. 9 and 10.

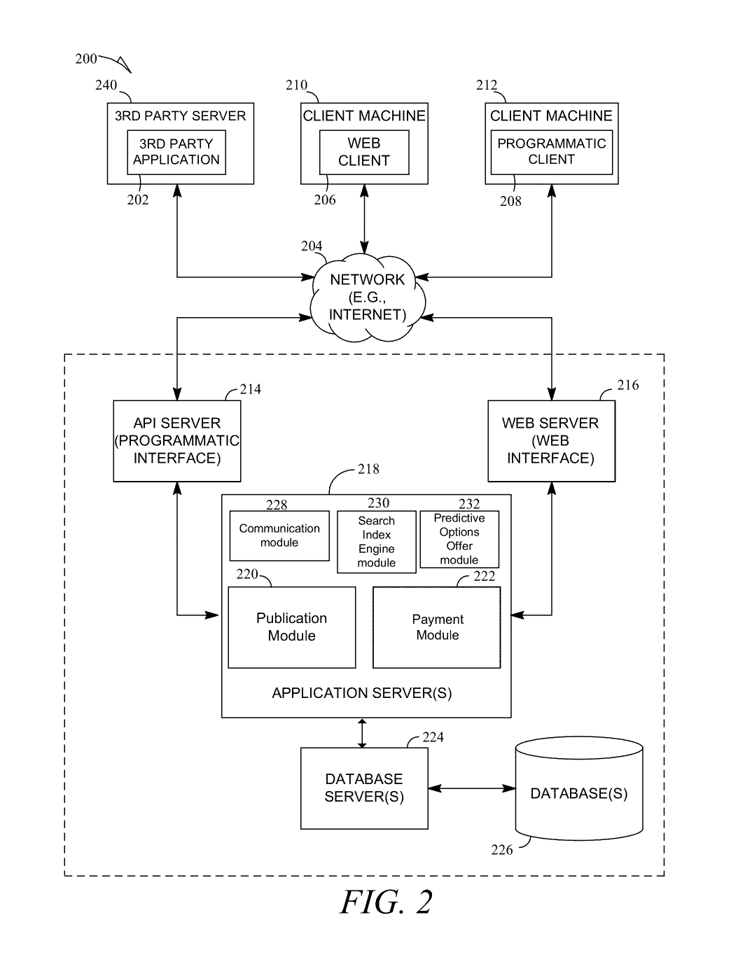

In an example embodiment, the affiliated merchants 130 can operate computer systems, such as an inventory system 132 or a Point of Sale (POS) system 134. The network-based publication system 120 can interact with any of the systems used by affiliated merchants 130 for operation of the affiliated merchant's retail or service business to collect historic pricing information. In an example, the network based publication system 120 can work with both POS system 134 and inventory system 132 to obtain access to inventory and pricing information available at locations operated by the affiliated merchants. This inventory information can be used in both generating product or service listings, and selecting and ordering search results served by the network-based publication system 120. An example network-based publication system 120 is detailed below in FIG. 2.

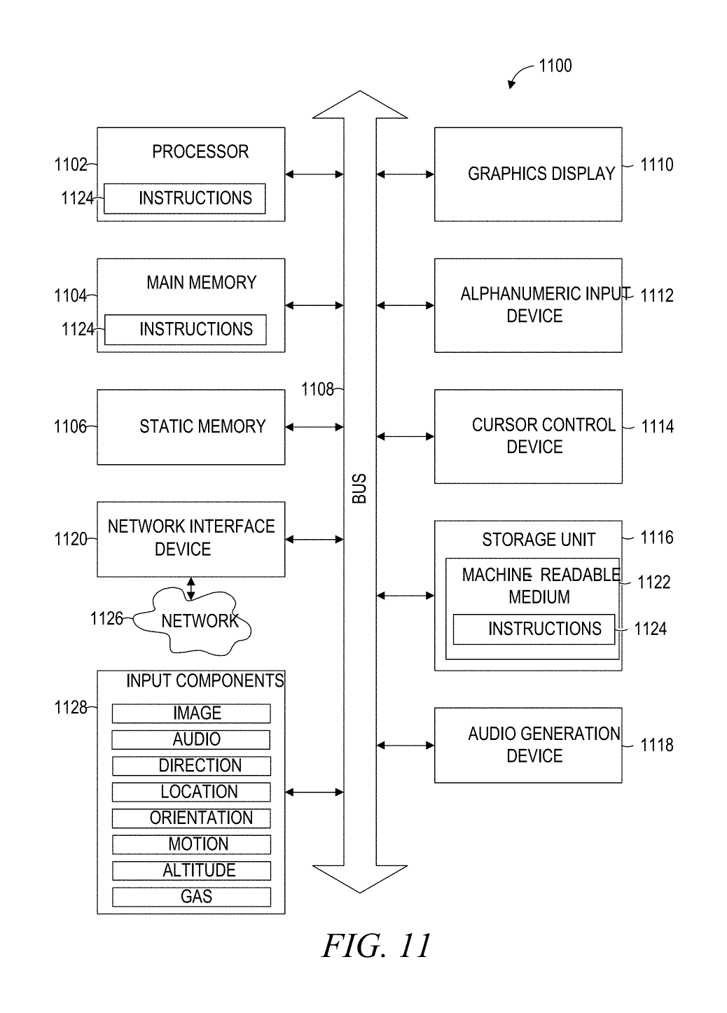

FIG. 2 is a block diagram illustrating a network-based publication system 200 for processing a search query, presenting search results (e.g., marketplace listings), and offering historic value based predictive commerce options as described more fully herein. The block diagram depicts a network-based publication system 200 (in the exemplary form of a client-server system), within which an example embodiment of Historic Value Based Predictive Options Commerce operations can be deployed. A networked system 200 is shown, in the example form of a network-based location-aware publication, advertisement, or marketplace system, that provides server-side functionality, via a network 204 (e.g., the Internet or WAN) to one or more client machines 210, 212. FIG. 2 illustrates, for example, a web client 206 and a programmatic client 208 executing on respective client machines 210 and 212. In an example, the client machines 210 and 212 can be in the form of a mobile device, such as client computing device 115 detailed in FIG. 11.

API server 214 and a web server 216 are coupled to, and provide programmatic and web interfaces respectively to, one or more application servers 218. The application servers 218 host one or more application server modules, comprising payment modules 222, search engine index modules 230, communication modules 228 having a receiver and a transmitter, and historic value based predictive commerce option modules 232. The application servers 218 are, in turn, shown to be coupled to one or more database servers 224 that facilitate access to one or more databases 226. In some examples, the application server 218 can access the databases 226 directly without the need for a database server 224.

The application server 218 modules may provide a number of publication and search functions and services to users, or third party partners, that access the networked system 200. The payment modules 222 may likewise provide a number of payment services and functions to users. The payment modules 222 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules of the application server 218, within retail locations, or within external online retail venues. The payment modules 222 may also be configured to present or facilitate a redemption of historic value based predictive commerce option offers, generated by the predictive options offer modules 232, to a user during checkout (or prior to checkout, while the user is still actively shopping).

The historic value based predictive commerce option offer modules 232 may be configured to generate buy versus rent commerce options and displaying these options as well as displaying historical pricing data, estimated buyback price(s) and total cost of ownership to users. The historic value based predictive commerce option offer modules 232 may also provide dynamic context sensitive offers such as coupons or immediate discount deals on targeted products or services, as well as commerce options and consumer recommendations, to users of the networked system 200.

The historic value based predictive commerce option offer modules 232 can be configured to use all of the various communication mechanisms provided by the networked system 200 to present historic value based commerce offer options to users and third party partners. The historic value based predictive commerce option offer options can be personalized based on current location, time of day, buyback period, user profile data, past purchase history, or recent physical or online behaviors recorded by the network-based system 200, among other things (e.g., context information).

While the publication modules of the application server 218 are shown in FIG. 2 to form part of the networked system 200, it will be appreciated that, in alternative embodiments, the payment modules 222 may form part of a payment service that is separate and distinct from the networked system 200. Additionally, in some examples, the historic value based predictive commerce option offer module 232 may be part of the payment service or may form an offer generation service separate and distinct from the networked system 200.

Further, while the system 200 shown in FIG. 2 employs a client-server architecture, the embodiments of the present invention are, of course, not limited to such an architecture, and could equally find application in a distributed, or peer-to-peer, architecture system, for example. The various publication modules 220, payment modules 222, and historic value based predictive commerce option offer modules 232 could also be implemented as standalone systems that do not necessarily have networking capabilities.

The web client 206 accesses the various publication modules 220, payment modules 222, and historic value based predictive commerce option offer modules 232 via the web interface supported by the web server 216. Similarly, the programmatic client, or a third party partner, 208 accesses the various services and functions provided by the publication modules 220, payment modules 222, and historic value based predictive commerce option offer modules 232 via the programmatic interface provided by the API server 214. The programmatic client 208 may, for example, be a smartphone application that enables users to communicate search queries to the system 200 while leveraging user profile data and current location information provided by the smartphone or accessed over the network 200. The programmatic client 208 may also be a third party partner with license to provide comparison shopping data for its own commerce using a turnkey system accessed by API

FIG. 2 also illustrates this third-party program partner application 202, perhaps executing on a third-party partner server machine, as having programmatic access to the networked system 200 via the programmatic interface provided by the API server 214. For example, the third-party program partner application 202 may utilize information retrieved from the networked system 200 to support one or more features or functions on a website hosted by the third party partner. The third-party partner website may, for example, provide one or more promotional, marketplace or payment functions that are supported by the relevant applications of the networked system 200. Additionally, the third-party partner API may provide third party partners with access to the historic value based predictive commerce option offer modules 232 for configuration purposes. In certain examples, third party partners can use programmatic interfaces provided by the API server 214 to develop and implement rules-based pricing schemes that can be implemented via the publication modules 220, payment modules 222, and offer modules 232.

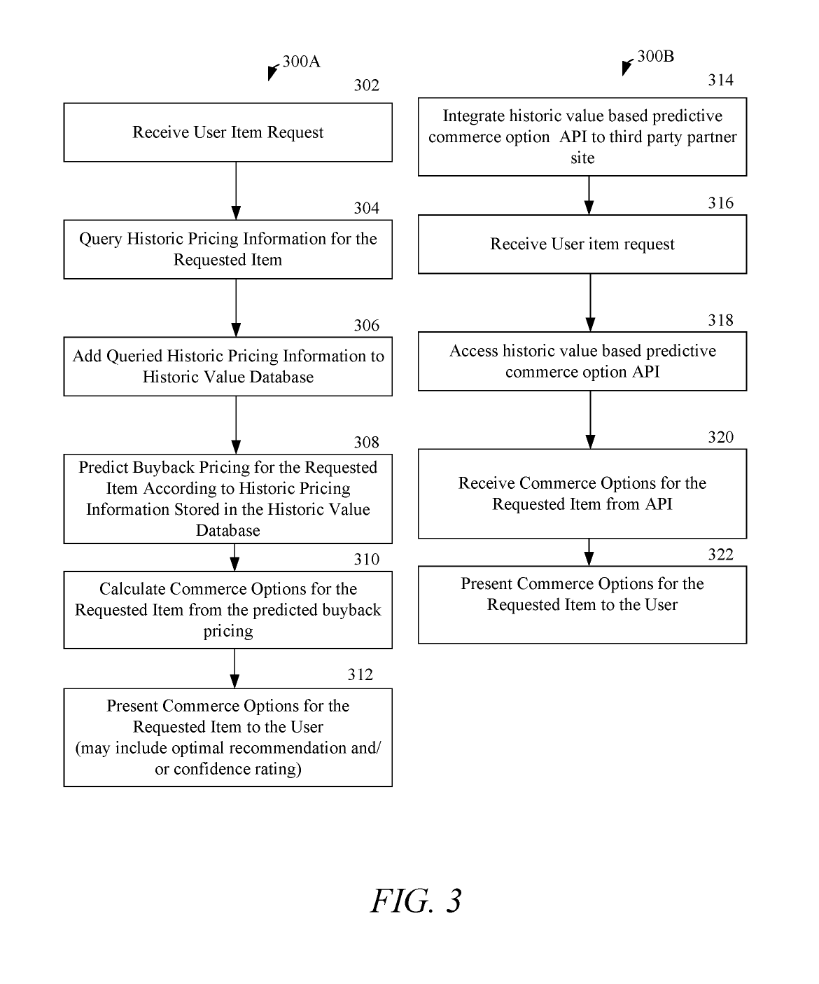

FIG. 3 shows a functional block diagram of Historic Value Based Predictive Options Commerce system operations 300A and 300B, according to some example embodiments. System operations 300A and 300B may be performed by the networked system 200 using modules of the application server 218 in conjunction with a data base(s) 226 and database server(s) 224 described above with respect to FIGS. 1 and 2. As shown in FIG. 3, the system operations 300A and 300B comprise operations 302-322. Operations 302-312 of operation 300A are operations performed in response to a user requested query. Operations 314-322 of operation 300B are operations performed by a third party affiliated partner.

Historic Value Based Predictive Options Commerce system operations may assist a consumer in deciding whether to buy or rent a considered item. In the exemplary textbook embodiment, a consumer may be assisted in deciding whether to rent or buy a textbook for a coming semester or other term period. As rentals become a larger part of commerce business models, they may not always be the least expensive option. Especially, when the consumer does not research, and take into account, the buyback price of an item when it is resold. Frequently, consumers rent textbooks they could buy and own less expensively. Historic Value Based Predictive Options Commerce offers a system to allow consumers to transparently evaluate the net cost of ownership and rental commerce options.

Beginning in system operation 302, an item request is received from a user. In the exemplary textbook embodiment, a student searching for an identified book item may enter a title, International Standard Book Number (ISBN), item number, search phrase, or any other identifier. One skilled in the art would understand that an identifier set pertains to particular items in other embodiments. System operation proceeds to operation 304.

In operation 304, historic value information (i.e. actual past pricing data) for the user requested item is queried from internal databases and affiliated merchants. In some embodiments, a third party API provides queried inventory information and historic pricing data for commerce options to third party program partners directly from affiliated merchants in real time in operations 314-322 of FIG. 3B. A lowest rental price and a lowest purchase price transacted at any time in the past may be included in an internal data base query and/or direct download from external affiliated merchant systems. System operation proceeds to operation 306.

In operation 306, any downloaded inventory historic value information is added to an internal historical value data base and system operation proceeds to operation 308. In operation 308, a future buyback price for the requested item is calculated from all of the historic value information related to the requested item that is stored in the internal historical value data base.

Data from the internal historical value data base may be used to calculate historical average buyback, sale and rent prices for new and used items (i.e. a book in the exemplary embodiment) in various conditions by resale period(s). In the exemplary text book embodiment, a resale period of particular interest may be a “rush period”, or the back to school months of August and September. A buyback period of interest may be December or other months occurring at the end of typical school term sessions. Averaged historical pricing is then used to calculate an estimated buyback price according to current data.

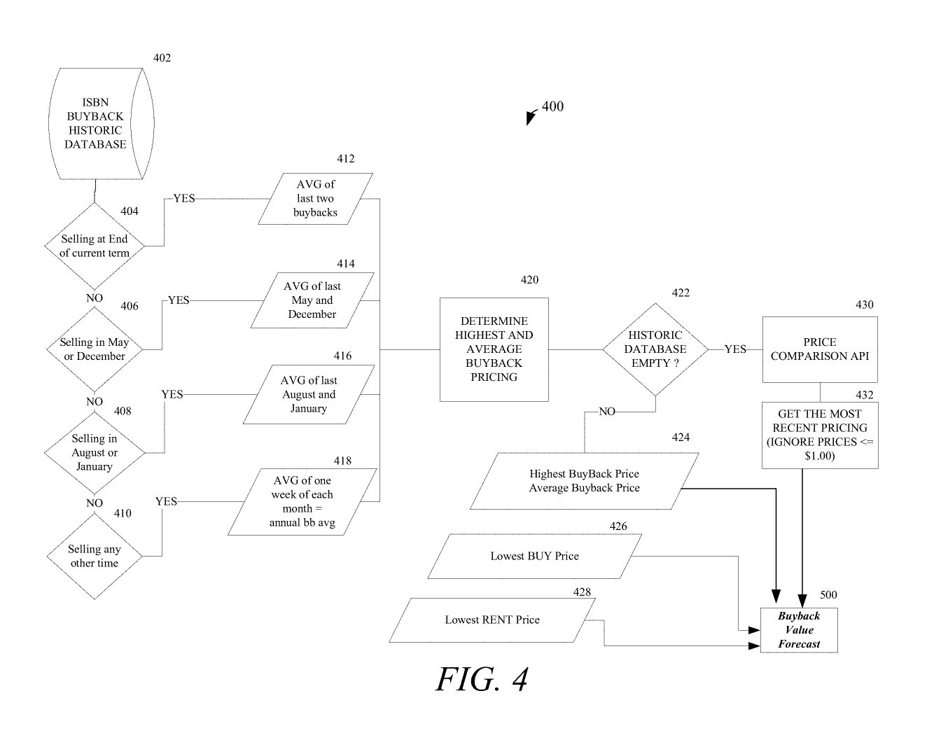

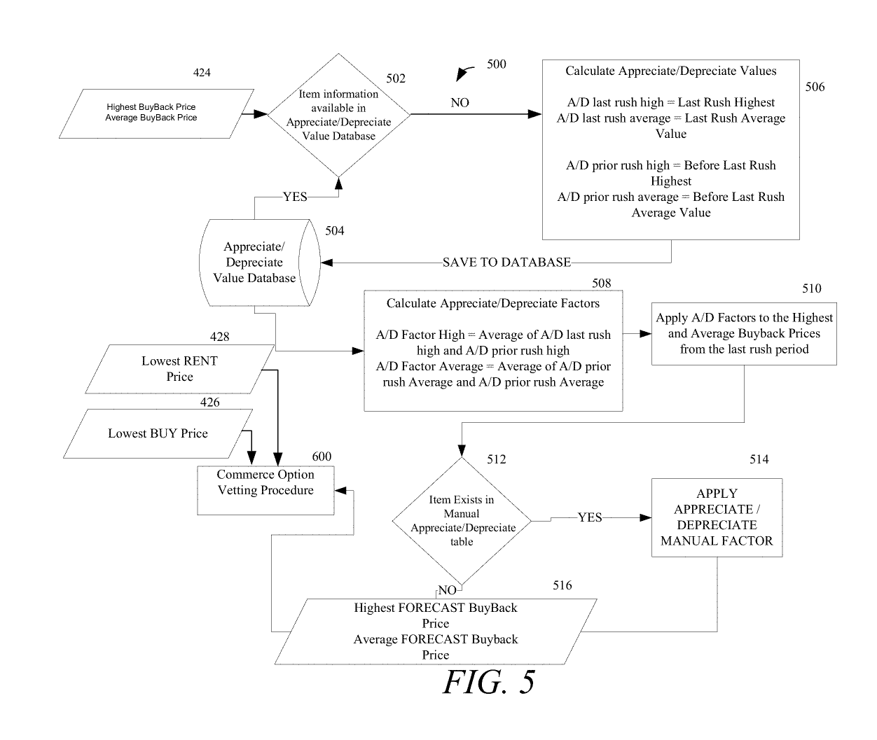

Averaged historical pricing may integrate appreciation or depreciation of an item into the historical buyback price and current price to give an estimated buyback price. Historic value averaging is detailed below in FIG. 4. Predictive buyback price estimation is detailed below in FIG. 5. System operation proceeds to operation 310.

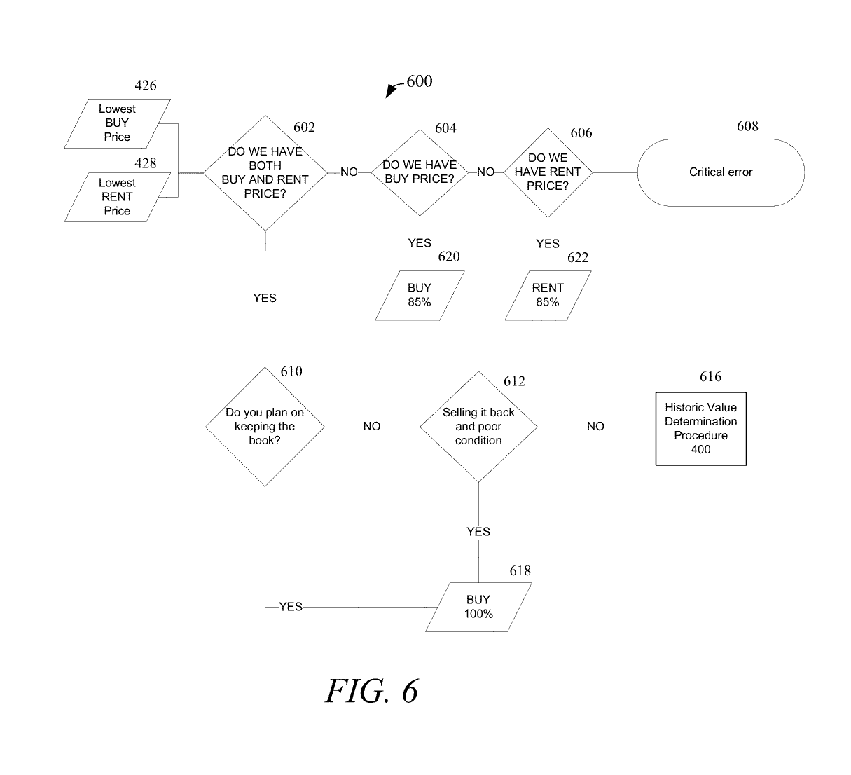

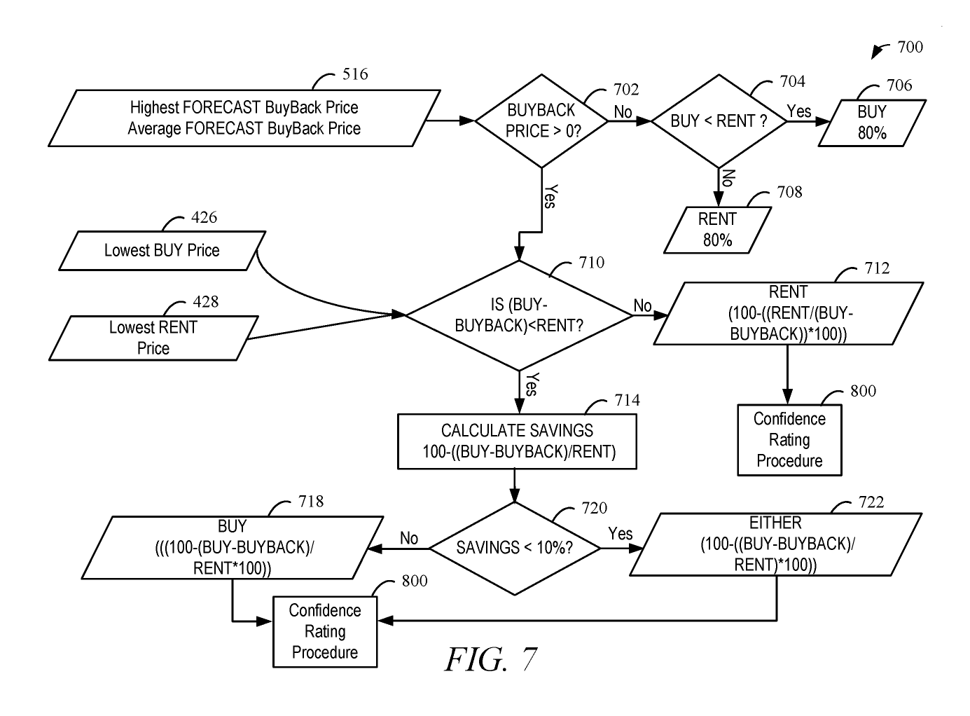

In operation 310, an optimal commerce option is calculated for the user requested item. An analysis of the net cost of ownership compared to the lowest current cost to rent is performed according to predictive value calculations and may optionally include personal preference factors. This analysis process may compare a current cost to rent an item with a calculated total cost to buy the item. The total cost to buy the item may be calculated by subtracting an estimated buyback price from the current purchase price. The total cost of ownership calculation is detailed below in FIGS. 6 and 7. System operation proceeds to operation 312.

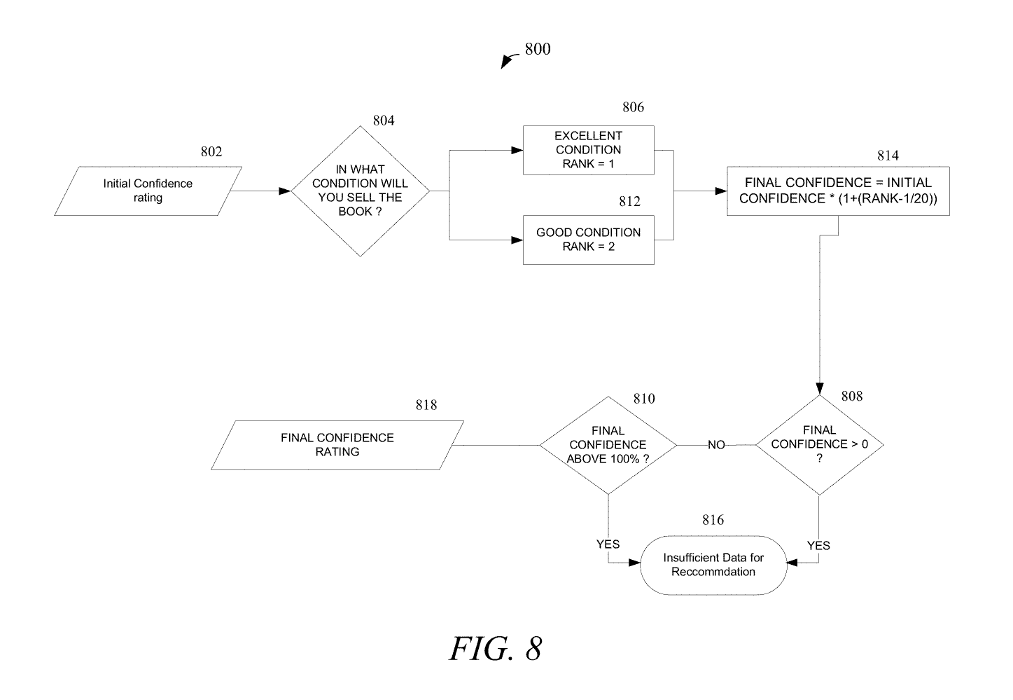

In operation 312, the presently calculated commerce options are presented to the user. In other embodiments, presently calculated commerce options may be provided to third party program partners. Net costs of ownership and rental options are displayed to assist the consumer's decision making process by providing a transparent cost analysis of all available commerce options. A graph showing historical buyback prices of the given item with the highest and average prices specified over time may also be displayed to the user. A best option according to the currently calculated data may also be recommended to the user. The best option may also be accompanied by a confidence rating in the accuracy of the calculation for the estimated buyback value. The buyback confidence rating process is detailed in FIG. 8.

Operations 314-322 of operation 300B may be performed by an affiliated third party partner or licensee. In operation 314, an affiliated third party partner or licensee first integrates the Historic Value Based Predictive Commerce Option API to its own site such that it can receive a user item request 316 and access Historic Value Based Predictive Commerce Option functionality 318 to receive commerce options for the user requested item through the API 320 for presentation to the user 322.

FIG. 4 shows a detailed state diagram illustrating a Historic Value Determination Procedure 400, or historical pricing calculations, according to some example embodiments. The Historic Value Determination Procedure 400 yields historical highest and average buyback prices, as well as a lowest historical rent and purchase price, according to the historical pricing data in the Historic Value Database 402. A retrieval function accesses the Historical Value Database 402 to fetch actual previous purchase, rental and buyback pricing data for end of current term sales 404, sales in May and/or December rush periods 406, sales in August and/or January rush periods 408, and other sale periods 410.

An average buyback value for the last two end of term periods is calculated from end of term sales data 412. An average buyback value for the last May and December rush periods are calculated from May and/or December rush period data 414. An average buyback value for the last January and August rush periods are calculated from May and/or December rush period data 416. An annual average buyback value for other sales periods is calculated from average pricing during one week of each month of the previous year 418. A final highest and average buyback pricing value 420 is then determined from the all of the averaged values 412-418.

If the Historic Value Data Base 422 provided sufficient data points for reliable averages 422, the final highest and average buyback pricing values 424, as well as the lowest historical purchase 426 and rental 428 prices are provided to a Buyback Value Forecast Procedure 500.

If sufficient empirical data points are not available in the Historic Value Database, a price comparison mechanism fetches both sale and buyback pricing data from affiliated merchants in real time for rental and new or used purchase of items in various conditions 430. The most recent pricing information obtainable over US $1.00 is substituted for the final highest and average buyback pricing values provided to the Buyback Value Forecast Procedure 500 in operation 432. The Buyback Value Forecast procedure 500 is detailed below in FIG. 5.

FIG. 5 shows a detailed state diagram for a Buyback Value Forecast procedure 500, i.e., predicting future buyback pricing. The Buyback Value Forecast Procedure 500 forecasts a future highest and future average buyback value 516 for the user requested item by applying calculated Appreciation/Depreciation factors (A/D factors) to the historical pricing data in the Historic Value Database 402. Application of the A/D factors to historical pricing data accounts for appreciation, depreciation and item popularity of the user requested item in order to estimate a future buyback price.

The Buyback Value Forecast Procedure 500 inputs the historical highest and average buyback prices 424 for the user selected item from the Historic Value Determination procedure 400 for two periods, the last rush period and the rush period prior to the last rush period. These historical input values are assigned to four A/D values (A/D last rush high, A/D last rush avg, A/D prior rush high and A/D prior rush avg, respectively) 506. A first A/D factor (AD factor high) is calculated by averaging the assigned values of AD last rush high and A/D prior rush high 508. A second A/D\ factor (A/D factor avg) is calculated by averaging the assigned values of A/D last rush average and A/D prior rush average 508.

A value adjustment mechanism adjusts the historical highest and average buyback prices from the last rush period by applying the dynamically calculated A/D factors. Available A/D values in an A/D value data base are examined for timeliness in operation 502. In one embodiment, previously stored A/D values for the user requested item are examined to determine if stored A/D values are less than one day old. If the values are less than one day old, the A/D values stored in the Appreciate/Depreciate Value Database 504 are used, such that it is not necessary to perform the A/D value calculations 506 again that day, thus speeding up the Buyback Value forecast process 500. If stored A/D values for the user requested item are more than one day old, the A/D values are calculated anew 506 and stored in the A/D value database 504 such that repeating the A/D value calculation is unnecessary during that same day. In other embodiments, time periods of other than one day may be used without departing from the scope of the invention.

The Appreciate/Depreciate Factors are calculated by averaging the A/D last rush high and A/D prior rush high values to produce A/D factor high, and averaging A/D last rush average and A/D prior rush average values to produce A/D factor average 508. A/D factor high is applied to the highest buyback price 424 for the last rush period to produce a highest forecast buyback price 516, and A/D factor average is applied to the average buyback price 424 for the last rush period to produce an average forecast buyback price 516 in operation 510.

If predetermined Manual Depreciation/Appreciation factors are present in a Manual Appreciation/Depreciation table 512, the Manual Appreciation/Depreciation factors are reapplied to the highest and average buyback values 424, adjusting any previously calculated AID factors 508, to calculate the highest forecast buyback price and average forecast buyback prices 516. When predetermined Manual Appreciation/Depreciation factors are not present in the Manual Appreciation/Depreciation table 512, no further factor is applied to calculate the highest forecast buyback price and average forecast buyback price 516. The predetermined AID factors may be applied to increase the accuracy of the future price predictions for the user requested item when conditions of erratic pricing behavior or lack of AID value data are present.

The lowest historical rent 428 and purchase prices 426 for the user selected item input from the Historic Value Determination procedure 400 are provided to the Commerce Option Vetting Procedure 600. The Commerce Option Vetting Procedure 600 is detailed below in FIG. 6. The highest and average forecasted buyback prices 516, as well as the lowest historical rent 428 and purchase prices 426 are then also provided to a Commerce Option Comparator Procedure 700. The Commerce Option Comparator Procedure is detailed below in FIG. 7.

FIG. 6 shows a detailed state diagram illustrating a Commerce Option Vetting Procedure 600, or predictive options vetting process, according to some example embodiments. The Commerce Option Vetting Procedure 600 vets the historic pricing information for critical failures (i.e. any circumstance where commerce recommendations cannot be produced). The Commerce Option Vetting Procedure 600 inputs the lowest historical rent 428 and purchase 426 prices the from the Historic Value Determination procedure 400.

A critical failure may result from insufficiently available historical pricing data, consideration of an individual consumer's personal factors, or other reasons. The Commerce Option Vetting Procedure 600 first determines whether both historical lowest rent 428 and lowest purchase price 426 data is available 602 for the user requested item. If historical lowest purchase pricing data is available but historical lowest rental pricing data is not available, a buy recommendation is generated with an 85% confidence rating 620. If historical lowest rental pricing data is available but historical lowest purchasing pricing data is not available, a rent recommendation is generated with an 85% confidence rating 622. When neither historical rental nor purchasing data is available, a critical error is produced 608. A critical error 608 may cause the Commerce Option Vetting Procedure 600 to report an inability to recommend a commerce option.

When both historical lowest rent 428 and lowest purchase price 426 data is available 602, a personal preference for length of ownership may be examined 610. In the exemplary textbook embodiment, if the consumer prefers to permanently retain ownership of the textbook 610 or plans to sell it back in poor condition 612, a buy recommendation is generated with a 100% confidence rating 618. Likewise, if the consumer prefers to retain ownership of the textbook permanently 614, a buy recommendation is generated with a 100% confidence rating. Otherwise, the Historic Value Determination Procedure 400 is implemented to determine historical pricing calculations. In the exemplary textbook embodiment, other personal factors may include ratings by a user of his or her level of book care, risk adversity and so on.

FIG. 7 shows a detailed state diagram illustrating a Commerce Option Comparator Procedure 700, or an algorithmic rental versus purchase comparison process, according to some example embodiments. The Commerce Option Comparator Procedure 700 determines the most advantageous commerce option according to the historical pricing data and forecast buyback values. The Commerce Option Comparator Procedure 700 inputs the highest and average forecasted buyback prices 516 from the Buyback Value Forecast Procedure 500, and the lowest historical rent 428 and purchase prices 425 the from the Historic Value Determination Procedure 400.

If the highest and average forecasted buyback prices 516 are less than zero 702, and the purchase price is less than the rental fee 704, a buy recommendation is generated with an 80% confidence rating 706. When the purchase price is greater than the rental fee, a rent recommendation is generated with an 80% confidence rating 708.

If the highest and average forecasted buyback prices 516 are greater than zero 702, the lowest historical rent 428 and purchase prices 426 are examined 710. If the difference between the lowest current purchase price and the highest forecast buyback price is not less than the lowest rental price 710, a rent recommendation is generated with an initial confidence rating equal to 100% minus the lowest historical rent price divided by the net cost of ownership multiplied by 100 712. This initial confidence rating is provided to a Commerce Option Final Confidence Rating Procedure 800.

If the difference between the lowest current purchase price and the highest forecast buyback price is less than the lowest rental price 710, the potential amount of savings by purchasing, rather than renting is examined. The savings are calculated as a percentage by subtracting the net cost of ownership of the item divided by the lowest historical rental price from 100% 714. If the savings are greater than 10% 720, a buy recommendation is generated with an initial confidence rating equal to 100% minus the lowest historical rent price divided by the net cost of ownership multiplied by 100) 718. The initial confidence rating is provided to a Commerce Option Final Confidence Rating Procedure 800. If the savings are less than 10% 720, a buy recommendation is generated with an initial confidence rating equal to 100% minus the lowest historical rent price divided by the net cost of ownership multiplied by 100) 722. The initial confidence rating is provided to a Commerce Option Final Confidence Rating Procedure 800. The Commerce Option Final Confidence Rating Procedure 800 is detailed below in FIG. 8.

FIG. 8 shows a detailed state diagram illustrating a Commerce Option Final Confidence Rating Procedure 800, according to some example embodiments. A final confidence rating comprises checks for confidence rating errors and incorporates the user's personal preference factors. The Commerce Option Final Confidence Rating Procedure 800 inputs an initial confidence rating 802 from the Commerce Option Comparator Procedure 700. The personal preference factors illustrated in FIG. 8 are shown for simplicity and ease of understanding as personal preference factors related to user requests for the exemplary textbook. One skilled in the art would, however, understand that the personal preference factors incorporated in a final confidence rating may vary and/or pertain specifically to the type of item being requested by the user in other embodiments. The Initial Confidence Rating 802 is adjusted for each available personal preference factor to yield an Adjusted Confidence Rating. The Adjusted Confidence Rating is checked for errors. If errors are detected in the Adjusted Confidence Rating, an insufficient data for recommendation report is returned. Otherwise, the Final Confidence Rating is equal to the Adjusted Confidence Rating.

In the exemplary textbook embodiment, the Initial Confidence Rating 802 may be adjusted by an anticipated item care personal preference ranking of 1 806 or 2 812 according to book condition 804. The adjusted confidence rating is equal to the Initial Confidence Rating multiplied by (1+(Rank−1/20)) 814. Any number or type of personal preference factors may be used to adjust the Final Confidence Rating in a like manner according to the specific type of item requested by a user.

After the Initial Confidence Rating has been adjusted for all of the available personal preference factors, the Adjusted Confidence Rating is checked for errors. If the Adjusted Confidence Rating is less than zero 806 or greater than 100% 810, an insufficient data for recommendation report is returned 816. Otherwise, the Final Confidence Rating is equal to the Adjusted Confidence Rating 818.

FIG. 9. illustrates a user interface for Historic Value Based Predictive Options Commerce, according to the exemplary textbook embodiment. Here, a graph showing historical buyback prices of the requested textbook item with the highest and average historical prices specified is displayed with a net cost comparison for rent versus buy commerce options and user personal preference questions 900.

FIG. 10. illustrates another user interface for Historic Value Based Predictive Options Commerce, according to the exemplary textbook embodiment. Here, current prices for the user requested textbook item from various affiliated merchants are shown 1000.

FIG. 11 is a block diagram illustrating components of a machine, according to some example embodiments, able to read instructions from a machine-readable medium and perform any one or more of the systems and methodologies for Historic Value Based Predictive Options Commerce discussed herein. FIG. 11 is a block diagram illustrating components of a machine 1100, according to some example embodiments, able to read instructions 1124 from a machine-readable medium 1122 (e.g., a machine-readable storage medium, a computer-readable storage medium, or any suitable combination thereof) and perform any one or more of the methodologies discussed herein, in whole or in part. Specifically, FIG. 11 shows the machine 1100 in the example form of computer system, within which the instructions 1124 (e.g., software, a program, an application, an applet, an app, or other executable code) for causing the machine 1100 to perform any one or more of the Historic Value Based Predictive Options Commerce methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment.

The machine 1100 may be a server computer, a client computer, a personal computer (PC), a tablet computer, a laptop computer, a netbook, a cellular telephone, a smartphone, a STB, a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics, or video, display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touch pad, a trackball, a joystick, a motion sensor, an eye tracking device, or other pointing instrument), a storage, or drive, unit 1116, an audio signal generation device 1118 (e.g., a sound card, an amplifier, a speaker, a headphone jack, or any suitable combination thereof), and a network interface device 1120 for communicating with a data communications network 1126.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over a network 1126 via the network interface device 1120. For example, the network interface device 1120 may communicate the instructions 1124 using any one or more transfer protocols (e.g., hypertext transfer protocol (HTTP)).

In some example embodiments, the machine 1100 may be a fixed or portable computing device, such as a desktop computer, laptop computer, smart phone or tablet computer, and have one or more additional input components 1128 (e.g., sensors or gauges). Examples of such input components 1128 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to send, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Thus, a novel and improved method and apparatus for historic value based predictive options commerce have been described. Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

The computer/machine-readable medium 1122 may be embodied in a computer-program product. By way of example, a computer-program product may include a computer/machine-readable medium 1122 in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, in which reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. sctn.112, sixth paragraph, unless the element is expressly recited using the phrase “means for” or, in the case of a method claim, the element is recited using the phrase “step for.”

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A commerce system comprising:
a communication module for receiving, from a user, an item request;
a search index engine for querying historic pricing information for the requested item;
a historic value data base for storing item specific historic pricing information;
a predictive options offer module for predicting buyback pricing for the requested item according to historic pricing information in the historic value data base and calculating commerce options for the requested item from the predicted buyback pricing; and
a communication module for presenting the commerce options to the user.

2. The commerce system of claim 1 wherein the predictive options offer module calculates a purchase option and a rental option.

3. The commerce system of claim 1 wherein the predictive options offer module performs a buyback value forecast procedure.

4. The commerce system of claim 1 wherein the predictive options offer module performs a commerce option vetting procedure.

5. The commerce system of claim 1 wherein the predictive options offer module performs a commerce option comparator procedure.

6. The commerce system of claim 1 wherein the predictive options offer module performs a commerce option final confidence rating procedure.

7. The commerce system of claim 1 wherein the communication module presents a commerce option recommendation or a commerce option confidence rating associated with a commerce option, to the user.

8. A non-transitory machine-readable storage medium comprising instructions that, when executed by one or more processors of a machine, cause the machine to perform operations comprising:
receiving, from a user, an item request;
querying historic pricing information for the requested item;
adding the queried historic pricing information to an historic value data base;
predicting buyback pricing for the requested item according to historic pricing information in the historic value data base;
calculating commerce options for the requested item from the predicted buyback pricing; and
presenting the commerce options to the user.

9. The non-transitory machine-readable storage medium of claim 1 wherein the historic pricing information is queried from affiliated partners.

10. The non-transitory machine-readable storage medium of claim 1 wherein an affiliated merchant Application Program Interface (API) provides queried historic pricing information directly from affiliated merchants.

11. The non-transitory machine-readable storage medium of claim 1 wherein queried pricing information comprises a lowest rental price or a lowest purchase price transacted at any time in the past.

12. The non-transitory machine-readable storage medium of claim 1 wherein historic pricing information is used to calculate historical average buyback, sale and rent prices for new and used items.

13. The non-transitory machine-readable storage medium of claim 1 wherein historic pricing information is used to calculate commerce options for a specific resale period.

14. The non-transitory machine-readable storage medium of claim 1 wherein commerce options comprise a purchase option and a rental option.

15. An Application Specific Processor configured to:
receive, from a user, an item request;
query historic pricing information for the requested item;
add the queried historic pricing information to an historic value data base;
predict buyback pricing for the requested item according to historic pricing information in the historic value data base;
calculate commerce options for the requested item from the predicted buyback pricing; and
present the commerce options to the user.

16. The Application Specific Processor of claim 15 further configured to provide queried historic pricing information directly from affiliated merchants to third party program partners.

17. The Application Specific Processor of claim 15 further configured to query pricing information comprising a lowest rental price or a lowest purchase price transacted at any time in the past.

18. The Application Specific Processor of claim 15 further configured to calculate historical average buyback, sale and rent prices for new and used items from historic pricing information.

19. The Application Specific Processor of claim 15 further configured to calculate commerce options for a specific resale period historic period.

20. The Application Specific Processor of claim 15 further configured to present a purchase option and a rental option to a user.
